(19) United States
(12) Patent Application Publication
(10) Pub. No.: US 2011/0070347 A1
(43) Pub. Date: Mar. 24, 2011

(54) COMPOSITION FOR BLOCKING INTERFIBRILLAR SPACES IN MEAT AND MEAT TREATMENT METHODS USING SAID COMPOSITION

(75) Inventors: Nohora Esperanza Guarin Torres, Bogota (CO); Gustavo Bastoospina, Bogota (CO)

(73) Assignee: Tecnoalimentica LTDA

(21) Appl. No.: 12/865,426

(22) PCT Filed: Jan. 31, 2008
(86) PCT No.: PCT/IB2008/001159

§ 371 Date: Nov. 30, 2010

(51) Int. Cl. A23L 1/314

(52) U.S. Cl. 426/296; 426/652; 426/541; 426/532; 426/549; 426/650; 426/589

(57) ABSTRACT

The invention relates to a gluten-free composition that acts as an agent for blocking interfibrillar spaces in meat tissue and to a method for forming a ‘cover’ which, during cooking, provides an increase in the vapour pressure inside the fillet or piece of meat and, consequently, in the temperature inside same, thereby reducing both cooking time and meat juice loss, which increases the mass yield, juiciness and flavour characteristic of meat at the end of the cooking process. In addition, the invention relates to methods for treating meat with said composition prior to cooking.

### FIELD OF INVENTION

The invention relates to a composition that acts as an agent for blocking interfibrillar spaces in meat tissue and to a method for forming a “cover” which, during cooking, provides an increase in the vapour pressure inside the fillet or piece of meat and, consequently, in the temperature inside of it, thereby reducing both the cooking time and meat juice loss, resulting in an increase of the mass yield, juiciness and characteristic flavour at the end of the cooking process. In addition, it makes part of the invention, the treatment methods of fillets and pieces of meat with the mentioned composition, prior to cooking by the different techniques habitually used at industry and domestic scale.

### STATE OF THE ART

One of the most desired characteristics by the meat consumer is its juiciness, flavour and nice appearance. It is widely known on the estate of the art, that during cooking, especially in large volumes, the meat portions suffer a substantial loss of weight due to dehydration or loss of juices. In addition, the meat portions experiment a substantial size reduction and changes on the flavour. This loss of juices and deterioration on the quality is even more noticeable on the food services where the operation leads to the stages of pre-cooking, cooling and subsequent heating.

The decrease on juiciness and hardening of the meat due to the loss of natural juices during cooking are unavoidable on the traditional cooking methods. The phenomenon is such that, it has been established the weight loss is around the rage of 20 to 45%, which represents a very high cost for those who commercialize meat products as finished goods, given that from a 100 gram piece of fresh meat, 55 to 80 grams of food is obtained, which immediately reflects an increase in price of the portion to the consumer.

In addition to the reduction problem, the cooking also influences negatively on the nutritional contents, due to the loss of water-soluble proteins and salts, and the tenderness, factors that significantly deteriorate the meats that are subjected to long periods of hot standby or pre-cooked fillets/pieces that require to be heated for their consumption.

Seeking to minimize the economic losses due to the loss of meat juices during cooking, different methods have been proposed, among them, the injection or diffusion to the inside of the meat, under vacuum, of brine containing phosphates and other filling agents, prior to cooking, with the purpose of inhibiting or partially compensating the juices loss and therefore weight loss, occurred during cooking. Even though, in principle, the idea reduces a little the loss of juices, the flavour changes, the benefit is minimal and the process is complicated given that additional steps are required, as are the production of the brine and its posterior injection into the foodstuff, frequently accompanied by a massaging process during a long period of time to achieve a uniform dispersion of the brine on the meat tissue, as it is reported in U.S. Pat. No. 4,746,522. Besides from the afore mentioned problems, these brines change the texture of the meats, which do not result attractive to the consumer.

Making use of this tendency, the European application 94301404.3 was proposed, which describes a process to obtain a soft and juicy microwave cooked meat, consisting on two steps: first, a moisture gain (by massaging) and second, the addition of a coating. For the first step, a solution with carrageenan, gelatin, phosphates, flour and salts, optionally with pectin, carboxymethyl-cellulose or methylcellulose, is used. For the second step, a mixture of flour, starch, protein from different sources, gelatin, salt, sugar, flavours and colorants is prepared. This process not only has the disadvantage or requiring several steps but is specifically oriented to the cooking of meat on microwaves and includes flour that, as it contains gluten, can't be consumed by people who are allergic to it.

Likewise, a method to reduce the loss of moisture using glycerol has been developed. As explained in U.S. Pat. No. 5,356,641, where a method is revealed to reduce the loss of moisture in the cooked meats and to intensify the impact of the seasonings flavour, based on a combined glycerol cover, as a protective an adhering cover, and a second one of seasoning or a paste resulting from the combination of the two of them, for this case, the cooking is done on the microwave (with a covering bag) or in a conventional oven.

Another alternative, probably the most investigated from all, is the use of covers to obtain a golden appearance and help to the retention of moisture inside the product during cooking. Unfortunately the cover agents are perceivable, poorly effective to retain the meat moisture, and result little desirable for those who don't want to consume breaded products given that the exterior appearance of the portion changes substantially due to the cover of the breaded crust and that they absorb 20% of oil during the frying process. At the end, the meats that are covered with visible covers have low acceptance on the consumer because, even though they may be transparent, they have traces of masses or dry appearance or starchy flavour.

On the other hand, most of the pastes used as breading have flour or derivatives containing gluten that under any circumstance can't be consumed by people susceptible to this component, among them, the inventions of the GB 2.0097.646, ES2110922 and CA2102724 applications, which finished product have a breaded and golden appearance.

Another case is the cover reported on the WO01/08513 document that reports an alimentary product that includes a breaded crunchy cover after its cooking in a microwave oven and reports a costly process that consists of bathing the food on a pre-mixed solution, covering the food with a pre-powder that includes wheat flavour, starch, protein, gum and/or salt; following by the wrapping of the food covered with a paste; apply breadcrumbs over the food covered with the mass; frying the breaded food rapidly and freeze.

On the same sense, the European application EP0258957 directed to a method for making a food covered with a sauce under a paste or a cover of paste and bread. The method is directed to form a covered food product that has a layer of moist sauce, formed in situ on the interface between the food and an external layer. An edible layer that contains starch is applied on a dry manner to a food, the dry cover absorbs the released moisture of the food substratum during cooking and a sauce is produced. The process includes the step of the posterior application of the paste cover or the paste and bread, using conventional techniques and then cooking the covered product. Again, the object of this invention are the breaded meat products or paste covered meat products, where the end product forms a breaded cover visible to the consumer, under which there is a sauce, equally visible to the consumer.

Another example of this type of developments of products to try to give a solution to the loss of moisture is found in U.S. Pat. Nos. 4,877,629, 4,948,608 and 4,978,541 that disclose the composition and manufacturing method of a covered foodstuff product that is impermeable to oil, retains water and the characteristic flavour and enhances flavour. Such composition consists of a barrier cover composed of starch, methylcellulose, xanthan gum and, optionally, flavour enhancers or flavour precursors. To obtain this functionality, such patents reveal the successive application of layers on the meat product, whether a layer that acts as a barrier and another that acts as a breading or at least a layer that serves as a barrier and breading or three layers, two serve as a barrier and a third as breading. Additional to the fact that the barrier on these cases is a breading, these inventions are only effective when the cooking is done by baking.

In the state of art, there are also known publications on edible barrier forming materials to improve the foods' shelf life, which include a variety of polysaccharides and proteins. Following there is mention of some cover compositions that include these.

The first of them is U.S. Pat. No. 5,997,918 that reports a food cover composition characterized by including at least 50% of corn starch, and additionally potato starch and dextrins, especially tapioca dextrin. The essence of the invention is the corn starch—tapioca starch ratio that is at least 2:1. Stopping on the meat's treatment process, it can be found that several steps are required before the meat can be subjected to cooking, which influences immediately on the cost and time to obtain the final product.

In addition, said patent reports the application of this cover over other types of products. Reference is not made to meat foods, which have nutritional, organoleptic and microbiologic characteristics which are completely different to the ones exhibited by vegetables. For example, the cooked meat dehydrates, turns hard, shrinks and experiments changes on its texture, flavour and appearance when cooked and is cooled, while vegetables, such as potatoes, have oxidation problems by contact with air.

Another approximation on this sense is divulged in application EP0669084 that refers to a process to prepare a cover to cook meat on the microwave oven, characterized in that it includes a water absorption step, and a covering step in which a powdered covering agent, that includes starch and proteins, is applied to the meat. For the first step, the critical particularities are a pH from 5.0 to 9.0 and a cation relation of Na+/K+/Ca++ of 2-10/1-6/1-4 and an aqueous solution that contains 2-8% of non-aqueous ingredients that include 5 to 20% hydrocolloids, 5 to 30% of gelatin, 8 to 40% of phosphates (polymers), 10 to 80% of flour and 5 to 35% of chlorine salts. During the second step, the solution employed includes starch selected from the group consisting of wheat flour, pre-gelatinized starch and combinations thereof, and a selected protein from a group consisting of egg albumin, isolated protein from vegetables and combinations of them. Although this invention can reduce the loss of meat juices, it can only be used for the preparation of meat on the microwave. Equally, as in the previously mentioned documents, the process for creating a cover is complex and due to the stages it includes, it consumes extra time and money.

To this group also belongs U.S. Pat. Nos. 5,540,944, 5,403,600 and the European patent 0643923A1 that describe processes to prepare a meat product with a cover. The covers described on these documents require to be subject to a process of agglomeration, granulation or instantiation, the mixture with water in low quantities and temperatures bellow 50° C. to avoid the coagulation of the protein or the crystallization of the starch. In addition to these covers, application WO86/00501, U.S. Pat. No. 4,935,251, U.S. Pat. No. 3,323,922 and U.S. Pat. No. 3,406,081 mention visible covers that include lipids or oil in water emulsions, which are visible after cooking and have a limited effect on the liquid retention.

Other methods and products to improve the retention of liquids are reported on the applications quoted bellow:

Application AR 248217 is based on the addition of water to the meat in a quantity between 3 to 25% the weight of the meat and the addition of 0.5 to 5% the weight of meat of a calcium compound, such as calcium hydroxide, calcium oxide and calcium carbonate with citric acid. The elaboration method of the additive results to be time-wasting and complex because the temperature, the solid content in the suspension, the quantity of ingredients in the mixture and the stirring time before the drying, are critical parameters in the determination of the final characteristics of the product.

U.S. Pat. No. 4,746,522 includes different components such as water, acetic acid and gelatin with which a viscous mixture is formed and is applied to the meat. This mixture is not designed especially for fillets or patties, and it doesn't specify that is imperceptible and can change the appearance of the meats.

In the mean time, US patent 2007092630 refers to compositions based on soy protein and a crossing agent that include at least 10% of aldehydes. In this case, the resulting compound is used on emulsified meat products such as sausages, hams, bologna, etc. and not over fillets or pieces of meat.

Other inventions are directed to products that include fat components, which treatment methods of the meat imply the injection of the food with appropriate injectable substances that include vegetable unsaturated oils, water and even cow meat fat or other saturated fats, as the ones reported on the applications CA1314429, DE102004054735, JP8140629, JP173097, JP9140352, JP8205823, JP 2005168319 and JP2005046090 that, in addition to the undesirable increase of fats on the food, they present complex processes for their application and generate a change in flavour and some cases, an unpleasant layer which is perceptible for the consumer.

Other applications, as JP 2005185142, even have proposed a method to improve the flavour and quality of the meat that consists of soaking the meat in a liquid that contains tea and alcohol, that without a doubt, changes the flavour of the product, and a method in which the applied product is protein/starch and the treatment method of the meat implies drying under conditions that are enough for the formation of a protein-starch complex without this last to be gelatinized.

U.S. Pat. No. 7,160,567 refers to a process to retain moisture in cooked food using a peptide composition, obtained from animal muscles, such preparation helps to retain the liquids of beef, pork meat, chicken, fish and seafood but its composition is different to the present patent and the elaboration costs are too high given that, to obtain the compound, a complex process is required for the obtaining and concentration of proteins from animal muscles.

Within this context, Colombian application CO 01-31383 from Tecnoalimenticia Ltda. was created, which had as object “a powdered composition to improve the yields and the nutritional, organoleptic and microbiological characteristics of meat products during and after cooking and a process for its application”, characterized by forming an imperceptible barrier over the patties, fillets or pieces that reduce the loss of juices and preserves flavour, juiciness and tenderness of the recently cooked food.

Although this was a good approach to the problem and the reported method of the application is simple since it was based on sprinkling of a compound, the layer formed didn't result to be imperceptible for the consumer taste and, also, it presents some disadvantages as containing gluten, which cannot be consumed by people sensible to this component.

Hence, it exists in the state of the art the need to count with a gluten-free product that really is imperceptible to the consumer and that decreases the exit of meat juices during cooking, reduces the industriousness and the cooking time required on the elaboration of the products, increases the yields and improves the flavour and juiciness of the food, independently of the type of meat to treat and the cooking system employed.

### DESCRIPTION OF THE INVENTION

Within this context, the applicant has developed a new composition, not breaded that, being applied in a superficial manner, acts on the meat, blocking the interfibrillar spaces during cooking, limiting the flow of juices to the surface of the piece of meat fillet or cooking losses, originated principally by the extruding effect of the meat tissue contraction during cooking.

Such composition is characterized for being gluten-free and for being absolutely imperceptible to the consumer because once it is applied to the portions, fillets or pieces of meat, with the increase on the superficial temperature it closes the interfibrillar channels on the surface at the same time that it is absorbed by the food.

It is known on the scientific literature that during rigor post mortis, the meat tissue experiments a transversal contraction of the muscular fibres, leaving spaces, or channels, between the fibre and the connective tissue, or endomysium, where in a progressive manner, liquids are accumulated and that during cooking, the meat experiments structural changes that decrease its water retention capacity. So, during the initial heating on the cooking, first there is a transversal shrinking of the fibres or muscular cells that enlarges the channels already formed during the rigor mortis between the fibres and the surrounding endomysium. Then, on the interval of 60°-70° C., a longitudinal contraction occurs simultaneously on the fibres as in the connective tissue that expel, by extrusion mechanics, the liquids to the exterior of the tissue along the longitudinal channels that exist around the fibres and bundles of muscular fibres, which is the cause of the greater loss of meat juices during cooking (See for example: Tornberg E. (2005) Effects of heat on meat proteins—Implications on structure and quality of meat products. 70, 493-508. Honikel K. O. (2004) Water-Holding Capacity of Meat. CABI Publishing Co. (Eds). “Muscle Development in Livestock Animls”. Pg. 389.399. P. Garcia., Andrés A., Martinez J., (2007). Effect of cooking method on mechanical properties, colour and structure of beef muscle. Journal of Food Engineering 80, 813-821).

The composition object of this invention, in joint action with the sarcoplasmic proteins present on the surface of the meat tissue, blocks or covers the interfibrillar spaces or channels between the bundles of fibre formed along the perimysium at the beginning of the cooking. As a result of the covering promoted by the composition object of this invention, the meat juices loss is substantially reduced; this increases the availability of water to promote de solubilisation of collagen when the inside tissue reaches a temperature above 60° C. This greater solubilisation of the collagen substantially increases the tenderness of the cooked meats using this technique. (See for example: Palka K. (1999). “Changes in intramuscular connective tissue and collagen solubility of bovine m. semitendinosus during retorting,” Meat Science, 53, 189-194). Likewise, the action of the compound object of this invention is such that is stabilizes the cooked portions surface moisture, giving it a more lustrous and appetizing appearance in comparison to meats cooked in the traditional way, without using this composition.

This improvement in the characteristics is maintained on fillets and meat pieces that have been pre-cooked and require later heating for their consumption.

By limiting the flow of liquid to the exterior of the meat tissue, due to the superficial cover of the spaces previously mentioned by the action of the composition object of this invention, the mass yield of the cooked portion is increased significantly. For example, the loses under controlled conditions of cooking on a broiler, grilled or on a convection oven of bovine meats usually don't exceed 10-15%, in comparison to 25%-35% of the cooked meats without using the composition object of this invention.

Likewise, the composition object of the present invention, by blocking the channels or superficial interstices of the meat tissue, promotes the formation of closed environments inside these channels, giving margin to the increase of the water vapour pressure in the inside of the meat tissue when cooking through dry methods. This increase on the internal pressure determines an increase in the equilibrium temperature of the water vapour, making the temperature of the tissue near the surface to increase in comparison to meats cooked without this composition. This increase on the surface temperature accelerates the transfer of heat to the inside of the portion, the denaturalization of the proteins and the hydrolysis of the collagen, achieving a reduction on the cooking time of the meat portion. This decrease on the cooking time is in average 20%; this increases up to 25% the productivity of commercial lines of meat cooking.

The composition of this invention used to block superficially the interfibrillar spaces or channels of the meat, comprises between 5 to 10% of proteins different from gluten, between 40 to 55% of carbohydrates, 0.3 to 0.5% of hydrocolloids, between 0.2 to 1.5% of polymers, between 0.5 to 1.0% non-adherents and between 30 to 50% of salts.

According to the invention, the proteins used are of vegetal origin, without including gluten, preferably soy protein, or of animal origin such as casein and albumin.

The carbohydrates are selected from a group that includes flours or native or modified starches obtained from corn, rice or yucca, dextrins or a combination thereof.

The hydrocolloids that are incorporated to the claimed composition are derived cellulose compounds, such as methylcellulose, carboxy-methylcellulose and hydroxy-propyl-methylcellulose, among other derivatives, xanthan gum, carrageenan, guar gum, or a combination thereof.

In relation to the polymers added to the composition, its found that they are pH adjusting polymers that belong to the polymer group of the sodium or potassium salts of phosphoric acids or combinations of them.

On the other part, the non-adherents are chosen from a group that includes silico-aluminates, magnesium carbonates, calcium orthophosphate or a combination thereof.

In relation to the salts, they are selected from the salts of lactic acid, such as calcium lactate, salts of glycolytic acid or glycolates, phosphates and/or a phosphate monoacid and/or a phosphate diacid, and salts of phosphoric acid, magnesium salts, sodium chloride or a combination thereof.

One preferred implementation of the composition of the invention includes antioxidizing agents, antimicrobials or bateriostatics, levanases, mixtures of dressings or seasonings and/or colorants.

The invention also relates with the method of superficially blocking the meat channels or interstices with which it can be obtained meat with excellent organoleptic properties and with minimal loss of natural juices. The estate of the technique reports complex and expensive methods to improve the meat liquids retention. Contrary to them, the method object of the present application is a method to block the meats interstitial spaces during cooking, which is characterized because it comprises only the following stages:
a. Applying superficially a blocking composition on a quantity of 0.3% to 2.0% by weight of meat.
b. Giving a superficial thermal treatment for 30 to 60 seconds, and,
c. Cooking the meat of step b).

Preferably, the composition applied on step (a) is the composition to superficially block the interfibrillar spaces of the meat defined previously.

According to the method reported here, the composition of step (a) can be applied over the surface by different methods that include, sprinkling the meat with the blocker alone or mixed with powdered condiments and/or fresh spices, such as onion paste, garlic paste, etc. Equally, this composition has the advantage of being able to be applied on liquid state, mixed with water as an emulsion or suspension, with which the application is speed up.

The composition can be applied on fresh meats on portions and packed at atmospheric pressure or vacuum for their refrigerated storage, or frozen and cooked later.

The composition and the method of the invention can be employed independently of the cooking method used. Preferably, step (b) implies that the meat can receive a superficial thermal treatment by means of a broiler, oil or hot air, a grill, roasting or with vapour. Preferably, step (c) of the method implies that the meat is prepared broiled or grilled, through frying on oil, on a conventional oven, convection based or hot vapour-air combined oven, on vapour, cooked on a bag at atmospheric pressure or vacuum, like the system denominate sous vide, or on sterilization systems.

On another embodiment of the invention, the method comprises an intermediate step of cooling before proceeding to the cooking in step (c), being then, the stages of the method, the following:
a. Apply the composition in an amount of 0.3% to 2.0% by weight of meat.
b. Give a superficial thermal treatment for 30 to 60 seconds,
c. Cool the meat of step b), and d. Cook the meat of step c).

A third embodiment of the invention refers to the method that comprises an intermediate step of vacuum package before proceeding to the cooking step (c), being, then, the stages of the method, the following:
a. Apply the composition in an amount of 0.3% to 2.0% by weight of meat.
b. Vacuum pack the meat of step a.
c. Give a superficial thermal treatment for 30 to 60 seconds, and,
d. Cook the meat of step c).

The composition and the method of the invention are equally useful for cooking beef, pork, chicken, veal, goat, sheep, fish, seafood, etc. such is its potential that it results ideal for the production of pre-cooked meats, soups and rices with pieces of meat, and products with meat stuffing, such as meat stuffed pastries, tamales, empanadas, among others.

Up till now, the elaboration process of rices and stuffed products mentioned on the previous paragraph implied cutting the meat to the indicated size, a first cooking of the meat, mixing the cooked meat with the other components, pre-cooking of the product with all its components and freezing or refrigerating it for the consumer to subject it to a final heating before their consumption. This process leads to an arduous labour, elevated energy consumption and a high juice loss due to the three cooking steps to which the meat has to be subjected to before being consumed.

Different from the conventional method, the application under study makes reference to a method for the elaboration of rices and stuffed products that include:
a. Cutting the meat into pieces of the required size for the filled product,
b. Applying the blocking composition of this invention to the pieces,
c. Mixing the raw meat with the other ingredients
d. Shaping the product with all the ingredients
e. Pre-cooking and freezing so the consumer can subject it to a final heating before consumption

Preferably, the blocking composition is applied over the surface of the meat fillet or piece on a proportion of 0.3 to 2.0% by weight of raw meat for all the techniques mentioned above. For the case of the stuffed products, it can be fixed, by the action of heat during 30 to 60 seconds, locking the exit of fluids in an absolutely imperceptible manner after the cooking and even after cooling, refrigeration or freezing and distribution as pre-cooked meat.

As it can be observed, the method of the invention has the advantage of eliminating the step of previous cooking of the meat independently from the other ingredients; this reduces the stages and the costs of the cooking without sacrificing the juiciness of the meat, the quality of its flavour and nutrients such as iron, vitamins and hydrosoluble proteins.

One alternative to the method described previously, is that the mixture of step (c) is done under vacuum and the method comprises an intermediate stage before step (d) that consists on vacuum packing the product. Being like this, the steps of the method are:
a. Cutting the meat into the required size pieces to be incorporated into the food,
b. Adding the blocking composition of the invention,
c. Mixing the meat with the other components
d. Vacuum packaging the product,
e. Pre-cooking the product with all its components and freezing so that the consumer can subject it to a final heating before consumption

### EXAMPLES

Comparative studies with other processes allowed to establish that in addition to the benefit of not containing gluten, the blocking composition and the methods reported here allow to reduce the cooking stages, which implies a reduction in costs, at the same time as improving the yields of the quantity of cooked meat, the nutritional, microbiological and organoleptic characteristics of the product, as shown on the following examples:

### Example 1

### Analysis of the Meat Yield

To evaluate the obtained yield with the meat treated with the composition claimed here and through the method of the present invention, the initial weight of two portions of raw meat were determined, one of them was used as control and was cooked without the addition of any product and the other portion was subject to the application of the composition of the invention in a quantity of 2.0% of the meat weight, superficial thermal treatment was applied for 30 to 60 seconds, and then the meat was cooked. The results are shown on table 1:

TABLE 1
Meat Yield

| | | | % LOSS WITH |
|---|---|---|---|
| | TYPE OF | % LOSS | BLOCKING |
| TYPE OF MEAT | COOKING | CONTROL | COMPOSITION |
| Beef fillet | Grilled | 25-35% | 10-15% |
| Chicken fillet | Grilled | 20-25% | 10-15% |
| Pork fillet | Grilled | 20-30% | 10-15% |
| Fish fillets | Grilled | 20-30% | 10-15% |

Source: Tecnoalimenticia Ltda. Performance studies of the composition object of the present invention.

### Example 2

### Nutritional Analysis

For making the food's nutritional analysis after cooking, the iron content, protein percentage and moisture percentage was evaluated for two meat portions that were treated in the same way as described on example 1, namely, one with the addition of the blocking composition of the invention and the others without it. The results are shown on table 2:

TABLE 2
Nutritional Analysis

| | | MEAT WITH |
|---|---|---|
| | | BLOCKING |
| | CONTROL | COMPOSITION |
| Iron Content (mg/kg) | 19 | 30 |
| Protein Percentage (%) | 20.6 | 24.14 |
| Moisture Percentage (%) | 44.9 | 58.6 |

The previous table shows that the meat to which the composition of the invention has been applied to, has 58% more iron than the meat that wasn't treated with the blocking composition. Likewise, the increase on the protein quantity of the cooked meat is 17.2%. Finally, the result reported for the percentage of moisture, clarifies that the meat treated with the composition of the invention contains 30.5% more meat juices than the meat used as control. This value is directly related to the vitamin, mineral and hydrosoluble protein content.

### Example 3

### Microbiological Analysis

For this study, a cooked meat without the addition of any product was used as control and meat that had been subject to the application of the composition of the invention on a quantity of 2.0% of the weight of meat, thermal treatment was applied for 30 to 60 seconds, and the meat was cooked. The results of the test are the following:

TABLE 3
Microbiological Analysis

| | | BLOCKING |
|---|---|---|
| MICROORGANISMS | CONTROL | COMPOSITION |
| Total count of aerobics on | 310 | 80 |
| plate | | |
| Count of moulds and yeasts | <10 | <10 |
| Total coliforms | <3.00 | <3.00 |
| Fecal coliforms | <3.00 | <3.00 |
| Salmonella | NEGATIVE | NEGATIVE |
| Positive Staphiloccocus | <100 | <100 |
| aureus Coag | | |

As it can be observed on the previous results, there exists a 74% decrease on the total aerobic microorganisms present on the sample treated with the blocking composition and the method of this invention.

### Example 4

### Organoleptic Analysis

The organoleptic characteristics of the treated meat were analyzed as explained on example 1. The results of the analysis are reported on table 4, presented bellow:

TABLE 4
Organoleptic Analysis

| | | BLOCKING |
|---|---|---|
| | CONTROL | COMPOSITION |
| TEXTURE (1) | X | XXX |
| JUICINESS (2) | X | XXX |
| FLAVOUR (3) | X | XXX |

(1) The meat cooked with the barrier is softer.
(2) The meat cooked with the barrier is more juicy
(3) The meat cooked with the barrier presents a more accentuated meat flavour

### Example 5

### Oil Absorption

Also, in the case that the meat is fried, the system allows to reduce the absorption of frying oil up to 40% not only for meats but for other stuffed products and potatoes, as shown on table 5.

TABLE 5
Oil Absorption

OIL ABSOPTION % m/m

| | WITH | WITHOUT | % OF LESS |
|---|---|---|---|
| | BLOCKING | BLOCKING | OILS |
| | AGENT | AGENTS | ABSORPTION |
| FRIED | 5.64 | 7.05 | 20% |
| CHICKEN | | | |
| FRIED PORK | 4.9 | 6.05 | 19% |
| FRIED | 14.5 | 22.8 | 36.40% |
| POTATOES | | | |

In addition to the mentioned on the previous tables, table 6 establishes other benefits of treating the meat with the blocking composition of the invention.

| BENEFITS WHEN COOKING MEATS | |
|---|---|
| WITH BLOCKING AGENT | RESULTS |
| Increase on the mass yield of | 15% to 20% or greater |
| the portion of the cooked meat | |
| Decrease on the cooking time of | >20% |
| the meat pieces | |
| Elimination of complaints and | 100% |
| claims due to the lack of | |
| juiciness, hardness and small | |
| size of the cooked portions of | |
| meat. | |

1. A composition to superficially block the interfibrillar spaces of the meat, characterized in that it is gluten-free and includes between 5 to 10% proteins other than gluten, between 40 to 55% of carbohydrates, between 0.3 to 0.5% of hydrocolloids, between 0.2 to 1.5% of polymers, between 0.5 to 1.0% of non-adherents and between 30 to 50% of salts.

2. The composition of claim 1 in which the proteins used are of vegetal origin, not including gluten, preferably soy protein.

3. The composition of claim 1 in which the proteins used are of animal origin, preferably casein and albumin.

4. The composition of claim 1 in which the carbohydrates are selected from the group that includes native or modified starches obtained from corn, rice or yucca, dextrins or a combination thereof.

5. The composition of claim 1 in which the hydrocolloids that are incorporated are selected from the group consisting of cellulose derivates, such as methylcellulose, carboxy-methylcellulose and hydroxy-propyl-methylcellulose, among other derivates, xanthan gum, carrageenan, guar gum, or combinations thereof.

6. The composition of claim 1 in which the polymers are pH adjusting polymers that belong to the group of polymers of phosphoric acid sodium salts or potassium salts or combinations thereof.

7. The composition of claim 1 in which the non-adherent agents are selected from the group that include silico-aluminates, magnesium carbonates, calcium orthophosphate or combinations thereof.

8. The composition of claim 1 in which the salts are selected from salts of lactic acid, calcium lactate, salts of glycolytic acid or glycolates, phosphates and/or phosphate monoacid and/or phosphate diacid, and salts of phosphoric acid, magnesium salts, sodium chloride or combinations of them.

9. The composition of claim 1 in which it also includes antioxidizing agents, antimicrobial, bacteriostatic, levanases, mixtures of dressings or seasonings and/or colorants.

10. A method to block the interstitial spaces of the meat during cooking in which it includes only the following stages:
a. Applying a blocking composition on a quantity of 0.3 to 2.0% by weight of meat.
b. Superficial thermal treatment for 30 seconds to a minute, and,
c. Cooking the meat of step b).

11. The method according to claim 10 in which the blocking composition of step a) is the composition of one of the previous claims.

12. The method according to claim 10 or 11 in which the application step a) consists on sprinkling the meat with the blocking composition alone or mixed with powdered condiments and/or fresh spices, such as onion paste, garlic paste, etc.

13. The method according to claim 10 or 11 in which the application step a) consists of mixing the blocking composition with water to form an emulsion or a suspension that is applied in a liquid state.

14. The method according to claim 10 or 11 in which the cooking on step c) of the method is done on the broiler or grill, on oil frying, on conventional, convection or vapour-air combined oven, on vapour, roasted, on bag at atmospheric pressure or vacuum (sous vide), in an autoclave under pressure.

15. The method according to claim 10 or 11 in which the method optionally includes an intermediate cooling step after the thermal treatment and before cooking step c).

16. The method according to claim 10 or 11 in which the method optionally includes an intermediate step of vacuum packing before the thermal treatment and before cooking step c).

17. The method according to claims 10 to 16 in which the meat used for application step a) is beef meat, pork, chicken, veal, goat, sheep, fish, seafood, etc.

18. One method to manufacture products that contain meat characterized because includes the following steps:
a. Cutting the meat into pieces of the required size for the stuffed product,
b. Applying the blocking composition of this invention to the pieces,
c. Mixing the raw meat with the other ingredients
d. Shaping the product with all its ingredients, pre-cooking it and freezing it so the consumer subjects it to a final heating before consumption

19. The method of claim 18 in which the product is selected from the group consisting of soups, rices and products with stuffings, such as meat stuffed pastries, tamales, empanadas, among others.

20. The method of claim 19 where the product is a stuffed product and the process includes the following stages:
a. Cutting the meat to the size of the pieces to be incorporated on the food,
b. Adding the composition according to one of the claims 1 through 9,
c. Mixing the raw meat with the other components of the filling,
d. Incorporating the filling inside the external dough,
e. Pre-cooking the product with all its components,
f. Packing the product and,
g. Freezing or refrigerating the product for its distribution to the consumer.

21. The method of claim 18 or 20 in which the quantity of composition added on step b) is between 0.3 to 2.0% of the meats weight.

22. The method according to claim 18 or 20 in which application step b) consists on sprinkling the meat with the blocking composition alone or mixed with powdered condiments and/or fresh seasonings, such as onion paste, garlic paste, etc.

23. The method according to claim 18 or 20 in which application step b) consists on mixing the blocking composition with water to form an emulsion or a suspension that is applied on liquid form.

24. The method according to claims 18 to 23 in which the meat is from beef, pork, chicken, veal, goat, sheep, fish, seafood, etc.

25. The method of claims 18 to 23 in which step c) consists on mixing the beef with rice, cereals, potatoes, yucca, pasta, vegetables, fruits, water, fats, among other foods.

26. The method of claim 18 in which the mixture of the meat with foods of claim 25 is done under vacuum.

27. The method of claim 18 or 20 in which step c) includes the mixture of the ingredients of the stuffing mentioned on claim 25 and the covering of such mixture with a dough in order to shape empanadas, meat stuffed pastries, tamales, etc.

28. The method of claim 18 or 20 in which the pre-cooking step of the product is done in a broiler or grill, by frying, on the conventional oven, convection oven, vapour-convection combination (combi) or by pressure on a sterilizer.

29. The method according to claim 18 or 20 in which the packing step is done under vacuum.
